(19) United States
(12) Patent Application Publication
(10) Pub. No.: US 2020/0278525 A1
(43) Pub. Date: Sep. 3, 2020

(54) MICROSCOPE FOR IMAGING A SAMPLE AND SAMPLE HOLDER FOR SUCH A MICROSCOPE

(71) Applicant: VIVENTIS MICROSCOPY SÀRL, Lausanne (CH)

(72) Inventors: Petr STRNAD, Lausanne (CH); Andrea BONI, Basel (CH)

(21) Appl. No.: 16/762,664

(22) PCT Filed: Nov. 8, 2018
(86) PCT No.: PCT/EP2018/080663

§ 371 Date: May 8, 2020

(30) Foreign Application Priority Data
Nov. 10, 2017 (CH) 01361/17

(51) Int. Cl. G02B 21/08; G02B 21/02; G02B 21/36; G02B 21/16; G01N 21/64

(52) U.S. Cl. CPC G02B 21/086; G02B 21/02; G01N 21/6458; G02B 21/16; G02B 21/36

(57) ABSTRACT

A microscope for imaging a sample is disclosed that includes an illumination objective arranged to eject an illumination light beam along an illumination path to illuminate the sample. A further illumination objective is arranged to eject a further illumination light beam along a further illumination path wherein the further illumination objective is arranged to eject the further illumination light beam substantially opposite to the illumination light beam. An imaging objective is arranged to receive detection light that is propagated along a detection axis to the illumination path and further illumination path. A sample holder is placed above the imaging objective and arranged to receive a sample. A holder support is arranged to receive the sample holder and to displace it relative to the imaging objective along three perpendicular axes and/or to rotate it around at least one rotation axis. The sample holder contains a separation wall creating linearly arranged compartments.

### TECHNICAL FIELD

The present invention relates to a microscope and to a sample holder for such microscope. Such microscopes and sample holders can be used for imaging and analysing a sample.

### BACKGROUND ART

Light Sheet (LS) or Selective Plane Illumination Microscopy (SPIM) is a fluorescence microscopy method in which an illumination beam path (excitation light) and a detection beam path (emission light from the sample) are substantially perpendicular to each other. The sample is placed at an intersection of these paths.

In some SPIM embodiments, hereafter referred to as inverted SPIM arrangements, the illumination and imaging objective are placed below a sample holder having a transparent bottom. A main advantage of the inverted SPIM arrangement is that the samples are kept separated from an immersion medium and the objectives and that a plurality of samples can be imaged in parallel. In one such embodiment described in EP 2 801 855 A1, the imaging objective is facing upwards at 30 degrees angle relative to the direction of gravity and a single illumination objective is placed orthogonal to the imaging objective. The sample is placed in a sample holder located above both objectives. Although multiple samples could be placed in the sample holder they are contained in a common volume and the microscope cannot thus be used for example to test the effect of multiple soluble drugs in parallel. In another inverted SPIM arrangement, described in WO 2015/036589 A1, a plate containing an array of cuvettes with transparent walls orthogonal to the illumination and detection beam path enable complete separation of multiple samples. Such array of cuvettes may however be more difficult to manufacture and impose constrains on the illumination and detection objective position. Moreover, both inverted SPIM arrangements use one illumination objective ejecting excitation light from one side. This light can be scattered or absorbed causing shadows behind absorbing or scattering parts of the sample which deteriorate the quality of the imaging. This particularly can be critical for optically dense samples and/or samples larger than 100 μm in diameter.

Therefore, there is a need for a system allowing for an efficient and precise microscopic or SPIM imaging of a plurality of samples.

### DISCLOSURE OF THE INVENTION

According to the invention this need is settled by a microscope as it is defined by the features of independent claim 1 and by a sample holder as it is defined by the features of independent claim 12. Preferred embodiments of the invention are subject of the dependent claims.

In particular, the invention deals with a microscope for imaging a sample comprising an illumination objective, a further illumination objective, an imaging objective, a sample holder and a holder support.

The illumination objective is arranged to eject an illumination light beam along an illumination path to illuminate the sample. Thereby, the illumination light beam can be straight, redirected by suitable optical means or have any other appropriate form, particularly a form of a light sheet. It can be a laser light beam having a range of wavelengths adapted to the properties of the sample. In particular, the wavelength of the laser light beam can be suitable for excitation of fluorophores and fluorescence imaging.

The further illumination objective is arranged to eject a further illumination light beam along a further illumination path, wherein the further illumination objective is arranged to eject the further illumination light beam substantially opposite to the illumination light beam. Such a microscope allows for dual or plural sided illumination of the sample. Particularly, this can be essential for comparably large samples such as biological samples. For example, such illumination allows for reducing shadow effects in or on the sample impairing the quality of the imaging.

The imaging objective is arranged to receive detection light comprising at least a portion of the light ejected from the sample. Thus, the light ejected from the sample can particularly comprise emitted fluorescence light or light ejected by the illumination objective and redirected or reflected by the sample. The detection light is propagated along a detection axis angled to the illumination path. The angle between the detection axis and the illumination path and further illumination path preferably is about 90°.

The sample holder is arranged to receive the sample. It has a portion which is transparent to the illumination light beam, the further illumination light beam and to the detection light. By means of the sample holder, the sample can be safely kept at an appropriate position. Like this, it can be precisely exposed to the illumination light beam. The imaging objective is positioned substantially below the sample holder. Thereby, the sample holder and the sample can conveniently be accessed, e.g., top down. This allows for manipulating the sample inside the sample holder or for replacing the sample holder in the holder support. Furthermore, the sample can be held in the sample holder only by gravity without the need for embedding in agarose or other support and multiple samples can be arranged next to each other.

The holder support is arranged to receive the sample holder and to displace the sample holder relative to the imaging objective. The holder support has a drive system arranged to displace the sample holder along three perpendicular axes and/or to rotate the sample holder around at least one rotation axis. Thereby, the holder support can be motorized. Like this, the sample holder can firmly be supported and located or relocated so that the sample is precisely positioned for illumination and imaging. In particular, this allows to visit or address multiple positions of the sample and multiple samples automatically.

The sample holder further comprises at least one separation wall creating at least two or an array of linearly arranged compartments. Plurality of samples can be held in these compartments by gravity and walls prevent mixing of liquid between compartments. This enables for example testing the effect of multiple soluble drugs in parallel.

Preferably, the transparent portion of the sample holder tapers along the direction of gravity. The term “direction of gravity” as used herein relates to a direction the force of the Earth's gravitation acts. The tapering transparent portion can have a rounded bottom. Such tapering transparent portion allows for exposing the sample to the illumination light beam from both sides. In particular, the sample can be efficiently illuminated in a comparably complete manner. Furthermore, such a tapering sample holder can be efficiently manufactured of various suitable materials.

Preferably, the illumination objective and the further illumination objective are placed in an immersion medium. Additionally or alternatively, the imaging objective preferably is placed in an immersion medium. In particular, in one advantageous embodiment all three objectives are placed in the same immersion medium. In another advantageous embodiment, the illumination objectives are air or gas objectives and the imaging objective is an immersion objective. Thereby, the imaging objective is placed in the immersion medium and the air illumination objectives are separated from the immersion medium by a transparent structure such as a glass window or the like.

Furthermore, the transparent portion of the sample holder preferably is made of a material which has a refractive index corresponding to a refractive index of the immersion medium. The transparent portion of the sample holder can also be made of a material with a refractive index substantially corresponding to a refractive index of a medium to be arranged inside the sample holder. Such embodiments allow to minimize light refraction due to different refractive indexes and, thus, improve the imaging quality.

Thereby, the immersion medium preferably is water or a water solution. The transparent portion of the sample holder is preferably made of fluorinated ethylene propylene and preferably having a thickness in a range of between about 10 μm to about 100 μm such as, e.g., 25 μm. Such material has a refractive index being essentially the same as the refractive index of water or water solutions.

The transparent portion of the sample holder is preferably made of a membrane connected to a body of the sample holder for increased mechanical stability and to provide an interface to the holder support. Preferably, the body of the sample holder is made of the same material as the transparent portion of the sample holder or of a material essentially having the same melting temperature as the body of the sample holder. The use of identical material enables easy attachment and sealing of the transparent portion to the sample holder body. Such attachment can be achieved for example by heat sealing, laser sealing or ultrasonic sealing. These sealing methods avoid the use of glues which can be toxic to the biological samples. In particular, the body of the sample holder can be made of injection molded fluorinated ethylene propylene and the transparent portion of a fluorinated ethylene propylene membrane.

The imaging objective is preferably oriented upwards essentially against the direction of gravity and the illumination objective and the further illumination objective are preferably oriented approximately horizontally, perpendicular to the direction of gravity. In this orientation the image generated by the microscope is located in a horizontal plane. In this orientation the user can easily relate the microscope image to the sample and the sample can be accessed, viewed, oriented and manipulated from top in a natural way.

Preferably, the microscope also has a light source directed essentially in the direction of gravity across the sample holder to the imaging objective, e.g. in the direction of gravity from above the sample holder through the sample into the imaging objective. This enables acquisition of a transmitted light image of the sample. Such direction of transmitted light propagation typically is perpendicular to the horizontal surface of the liquid samples which minimizes refraction at the air liquid interface and enables acquisition of high quality transmitted light image as well as the use of contrast technique such as phase contract.

Preferably, one of the axes of the holder support drive system is arranged to displace the sample along the axis of the imaging objective. In this configuration the drive system can displace the sample along this axis between acquisitions of images and acquire thus a whole sub-volume of the sample. This sub-volume will be for the user naturally oriented with one axis representing the direction of gravity or vertical direction. This can in particular be advantageous when user needs to view the sample inside the microscope using a stereo microscope mounted above the sample holder and manually orient or manipulate the sample inside the microscope.

Another aspect of the invention relates to a sample holder which can be suitable for a microscope as described above. The sample holder is arranged to receive a sample. It comprises: (i) a transparent portion which is transparent to a illumination light beam and to a detection light and which is made of a membrane of fluorinated ethylene propylene; (ii) a body to which the transparent portion is connected; and (iii) a separation wall to which the transparent portion is connected such that at least two linearly arranged compartments are created.

Such sample holder and its preferred embodiments described below allow for achieving the effects and benefits described above in connection with the microscope and its preferred embodiments. In particular, when being use together with such or similar microscope it can be beneficial. Furthermore, such sample holder allows for parallel or sequential processing of a plurality of isolated samples, treated for example with different soluble drugs, within the same microscope. Also, the sample holder can be efficiently manufactured at a well tailored shape suiting the situation given by the microscope it is intended to be used with.

Preferably, the transparent portion of the sample holder tapers along the direction of gravity. The body of the sample holder preferably is made of fluorinated ethylene propylene. Preferably, the transparent portion of the sample holder has a rounded bottom. Further, the transparent portion of the sample holder preferably is longitudinally shaped.

### BRIEF DESCRIPTION OF THE DRAWINGS

The microscope according to the invention and the sample holder according to the invention are described in more detail herein below by way of exemplary embodiments and with reference to the attached drawings, in which:

FIG. 1 shows a schematic overview of an embodiment of a microscope according to the invention having an embodiment of a sample holder according to the invention;

FIG. 2 shows a section of the microscope of FIG. 1;

FIG. 3 shows a side view of the sample holder of the microscope of FIG. 1;

FIG. 4 shows a bottom view of the sample holder of the microscope of FIG. 1;

FIG. 5 shows a transversal cross section of the sample holder of the microscope of FIG. 1; and

FIG. 6 shows a longitudinal cross section of the sample holder of the microscope of FIG. 1.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

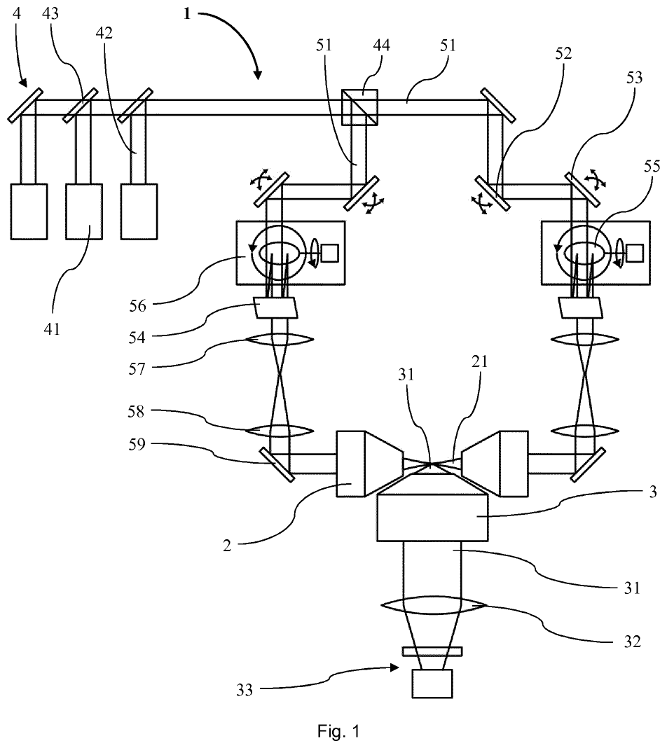

FIG. 1 shows an embodiment of a microscope 1 according to the invention. It comprises a beam generator 4 with three laser sources 41 ejecting light towards associated mirrors and dichroic mirrors 43. In particular, the ejected light 42 of the laser sources 41 is combined by the dichroic mirrors 43 to a common light beam.

The common light beam is directed to a beam splitter 44 which generates a light beam 51 and a deflected further light beam 51. The light beam 51 and the further light beam 51 are correspondingly processed by respective symmetrically arranged mirror components. For matter of simplicity, in the following only the travel of the light beam 51 is mentioned. However, it is understood that the same also applies to the further light beam 51.

The light beam 51 is reflected by two kinematic mirrors 52 and 53 which can be used to align the light beam 51 to the center of optical path. In particular, the compound movement of mirrors 52 and 53 can be used to translate or rotate the beam 51.

The light beam 51 is then reflected by fixed mirror 54 onto a rotatable mirror 55. In particular, the rotatable mirror 55 can be a mirror galvanometer scanner which allows for a fast beam movement within the exposure time to generate a light sheet. The rotatable mirror 55 is itself mounted in a rotational stage 56 to rotate the rotatable mirror 55 around a second axis perpendicular to the first rotational axis of the rotatable mirror 55.

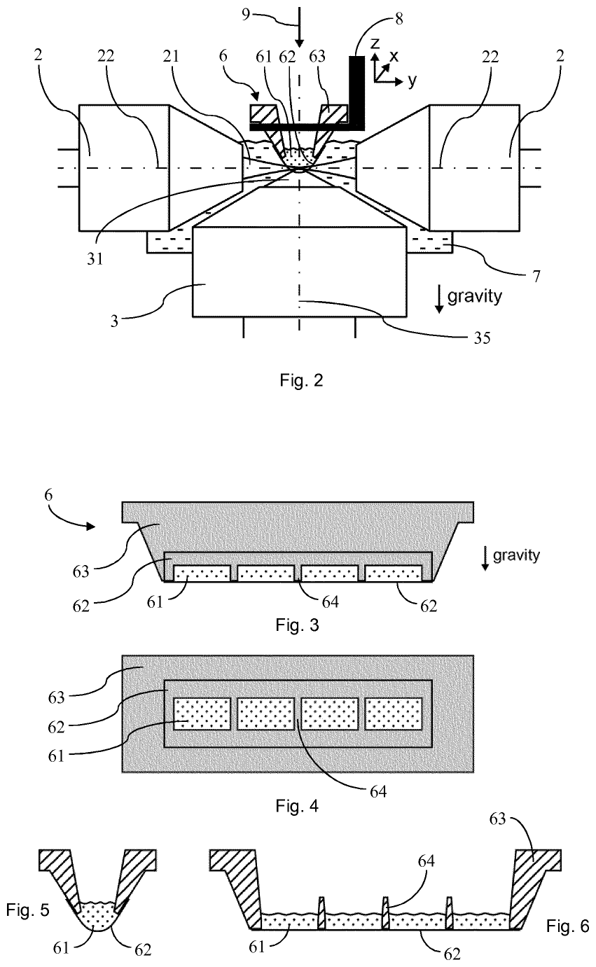

From the rotatable mirror 55, the light beam 51 is provided to a focussing lens 57 and a collimating lens 58. The rotatable mirror 55 is placed at the focus of the lens 57. The light beam 51 is then directed by a final mirror 59 to an illumination objective 2. The illumination objective 2 then ejects a focused illumination light beam 21 generated from the light beam 51 along an illumination path 22 (see FIG. 2).

Since the optical system described above is mirror symmetrically set up in duplicate, there are two illumination objectives 2 opposite to each other. They both eject the illumination light beams 21 towards each other along the illumination path 22. Like this, the illumination light beams 21 illuminate a sample 61 (see FIG. 2) from two opposite sides. The sample 61 emits detection light and part of it is collected by an imaging objective 3. Thus, it ejects detection light 31 propagated along a detection axis 35 (see FIG. 2) angled at 90° to the illumination path 22. The imaging objective 3 gathers the detection light 31 and provides it via a focusing lens 32 to a detector 33 comprising an emission filter and a camera.

In the context of the description of the Figs. the term “sample” or “sample medium” can relate to a single sample, a plurality of samples, to a medium being the sample itself or to a sample mixed or placed in a medium.

In FIG. 2 a section of the microscope 1 is shown in more detail. Thereby, it can be seen that centrally between the two illumination objectives 2 a sample holder 6 is positioned. The sample holder 6 tapers downwardly and has a rounded bottom. Part of the tapering section and the rounded bottom form a transparent portion 62 which can be made of membrane attached to the walls 63 of the sample holder 6. In particular, the transparent portion 62 is transparent for the illumination light beams 21 propagated along the illumination path 22 and the detection light 31.

The imaging objective 3 is arranged below sample holder 6 and the illumination objectives 2. Its orientation is perpendicular to the orientation of the illumination objectives 2. The imaging objective 3 and the illumination objectives 2 are placed in an immersion medium 7. The sample holder 6 is carried by a holder support 8 of the microscope 1 which allows for moving the complete sample holder 6. In particular, the holder support 8 has a drive system allowing a movement of the sample holder 6 with a moving axis which is parallel to the detection axis 35.

The sample holder 6 further has an interior which is open in an upward direction. In the sample holder 6 the sample medium 61 containing the sample is arranged. In particular, the sample holder 6 is closed in a downward direction, i.e. in a direction of gravity, such that the sample medium 61 is held inside the sample holder 6 by means of the gravity.

Above the sample holder 6 a LED light source 9 is positioned. The light source 9 is oriented such that it provides a transmitted light directed essentially in the direction of gravity and along the detection axis 35 across the sample holder 6 towards the imaging objective 3.

FIGS. 3 to 6 show details of the sample holder 6. As can particularly be seen in FIG. 5, the sample holder 6 tapers downwardly and has a rounded bottom. Part of the tapering section and the rounded bottom form a transparent portion 62 which can be made of membrane attached to the body 63 of the sample holder 6. In particular, the membrane of the transparent portion 62 and the body 63 can both be made of fluorinated ethylene propylene.

As best visible in FIGS. 3, 4 and 6, the sample holder 6 contains three separation walls 64 creating an array of four linearly arranged compartments. In each of the compartments, a sample 61 is held by gravity and the separation walls 64 prevent mixing of liquid between the compartments. The membrane of the transparent portion 62 is sealed to the body 63 and the separation walls 64.

This description and the accompanying drawings that illustrate aspects and embodiments of the present invention should not be taken as limiting-the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A microscope for imaging a sample comprising:
an illumination objective arranged to eject an illumination light beam along an illumination path to illuminate the sample;
a further illumination objective arranged to eject a further illumination light beam along a further illumination path wherein the further illumination objective is arranged to eject the further illumination light beam substantially opposite to the illumination light beam;
an imaging objective arranged to receive detection light comprising at least a portion of the light ejected from the sample, wherein the detection light is propagated along a detection axis angled preferably at about 90° to the illumination path and to the further illumination path;
a sample holder arranged to receive the sample and having a transparent portion which is transparent to the illumination light beam, the further illumination light beam and to the detection light, wherein the imaging objective is positioned substantially below the sample holder; and
a holder supportarranged to receive the sample holder and to displace the sample holder relative to the imaging objective wherein the holder support has a drive system arranged to displace the sample holder along three perpendicular axes and/or to rotate the sample holder around at least one rotation axis,
wherein the sample holder comprises at least one separation wall creating at least two linearly arranged compartments.

2. The microscope of claim 1, wherein the transparent portion of the sample holder tapers along a direction of gravity.

3. The microscope of claim 1, wherein the illumination objective and the further illumination objective in an immersion medium.

4. The microscope of claim 1, wherein the imaging objective is placed in an immersion medium.

5. The microscope of claim 3 or wherein the transparent portion of the sample holder is made of a material which has a refractive index corresponding to a refractive index of the immersion medium.

6. The microscope of any one of claim 3, wherein the immersion mediumis water or a water solution.

7. The microscope of claim 1, wherein the transparent portion of the sample holder is made of fluorinated ethylene propylene.

8. The microscope of claim 1, wherein the transparent portion of the sample holder is made of a membrane connected to a body of the sample holder.

9. The microscope of claim 8, wherein the transparent portion of the sample holder is made of the same material as the body of the sample holder or of a material essentially having the same melting temperature as the body of the sample holder.

10. The microscope of claim 1, wherein the imaging objective is positioned to be directed essentially against the a direction of gravity and the illumination objective and the further illumination objective are positioned to be directed essentially perpendicular to the direction of gravity.

11. The microscope of claim 1, further comprising a light source providing a transmitted light directed essentially in the a direction of gravity across the sample holder to the imaging objective.

12. The microscope of claim 1, wherein the holder support has a drive system with a moving axis parallel to the detection axis.

13. A sample holder arranged to receive a sample comprising:
a transparent portion which is transparent to an illumination light beam and to a detection light and which is made of a membrane of fluorinated ethylene propylene;
a body to which the transparent portion is connected; and
a separation wall to which the transparent portion is connected such that at least two linearly arranged compartments are created.

14. The sample holder of claim 13, wherein the transparent portion tapers along a direction of gravity.

15. The sample holder of claim 13, wherein the body is made of fluorinated ethylene propylene.

16. The sample holder of claim 13, wherein the transparent portion has a rounded bottom.

17. The sample holder of claim 13, wherein the transparent portion is longitudinally shaped.
